(19) United States
(12) Patent Application Publication
(10) Pub. No.: US 2014/0203205 A1
(43) Pub. Date: Jul. 24, 2014

(54) DOUBLE-LAYER COMPOSITE METAL POWDER PARTICLE AND METHOD OF MANUFACTURING SOFT MAGNETIC CORE

(71) Applicant: SAMSUNG ELECTRO-MECHANICS CO., LTD., Suwon (KR)

(72) Inventors: Hak Kwan KIM, Suwon (KR); No Il PARK, Suwon (KR); Sung Yong AN, Suwon (KR)

(73) Assignee: SAMSUNG ELECTRO-MECHANICS CO., LTD., Suwon (KR)

(21) Appl. No.: 14/146,495

(22) Filed: Jan. 2, 2014

(30) Foreign Application Priority Data
Jan. 24, 2013 (KR) 10-2013-0008260

(51) Int. Cl. H01F 1/01; H01F 41/02

(52) U.S. Cl. CPC H01F 1/01; H01F 41/0246
USPC 252/62.53; 419/64; 419/35

(57) ABSTRACT

There is provided a double-layer composite metal powder particle including an Fe-based powder, an insulating layer formed on a surface of the Fe-based powder, and a lubricating wax coating layer formed on the insulating layer.

### CROSS-REFERENCE TO RELATED APPLICATION

This application claims the benefit of Korean Patent Application No. 10-2013-0008260 filed on Jan. 24, 2013, with the Korean Intellectual Property Office, the disclosure of which is incorporated herein by reference.

### BACKGROUND

The present disclosure relates to a double-layer composite metal powder particle and a method of manufacturing a soft magnetic core by using the double-layer composite metal powder particle.

In general, soft magnetic materials have been used in various fields, such as for a stator, a rotator, an actuator, a sensor, and a core in a transformer of an electric device such as a core of an inductor and a motor. In the related art, a method of stacking and fixing several layers of processed steel plates to be integrated has been used to manufacture soft magnetic cores used as components in electric devices. However, in the case in which steel plates are stacked, difficulties in manufacturing products having relatively complex three dimensional shapes as well as scrap loss may occur.

Therefore, a method of high-pressure molding the soft magnetic powder has recently been introduced, and thus, a core having high degree of design freedom, in terms of a shape thereof, may be manufactured. The soft magnetic powder to be used in this case, a powder having magnetism when electricity is applied thereto, is generally based on Fe-based soft magnetic powder particles, and the soft magnetic powder particles are used to manufacture the soft magnetic core through a general powder metallurgical process.

For example, after the Fe-based soft magnetic material is prepared as a powder through a spraying method, a pulverizing method, or the like, a mechanical process or a heat treatment, or the like, is performed on the corresponding powder, such that a soft magnetic powder capable of being appropriately used as a core material may be manufactured. The prepared soft magnetic powder is pressing molded, such that a soft magnetic core having a desired shape may be formed.

### RELATED ART DOCUMENT

### Japanese Patent Laid-Open Publication No. 2011-029302

### SUMMARY

An aspect of the present disclosure may provide a double-layer composite metal powder particle and a method of manufacturing a soft magnetic core by using the double-layer composite metal powder particle.

According to an aspect of the present disclosure, a double-layer composite metal powder particle may include: an Fe-based powder; an insulating layer formed on a surface of the Fe-based powder and including an alkali-halogen compound; and a lubricating wax coating layer formed on the insulating layer.

The alkali-halogen compound may include lithium fluoride (LiF).

The insulating layer may have a thickness of 30 nm to 300 nm.

The lubricating wax coating layer may have a thickness of 300 nm to 700 nm.

A melting point of lubricating wax used in the lubricating wax coating layer may be 100° C. to 150° C.

The lubricating wax may include at least one of ethylene bis stearamide (EBS), zinc-stearate and polyethylene.

An average particle size of the Fe-based powder may be 100 μm to 200 μm.

The Fe-based powder may include at least one alloying element of silicon (Si), aluminum (Al), chromium (Cr), molybdenum (Mo) and boron (B).

The alloying element may be included in a content of 3.5 to 10 wt % based on the Fe-based powder.

According to another aspect of the present disclosure, a method of manufacturing a soft magnetic core may include: preparing an Fe-based powder; forming an insulating layer including an alkali-halogen compound on a surface of the Fe-based powder; forming a lubricating wax coating layer on the insulating layer to prepare a double-layer composite metal powder particle; preparing a slurry including the double-layer composite metal powder particle; and pressing molding the slurry to manufacture a core.

The pressing molding may be performed at a temperature of 150° C. to 250° C.

The pressing molding may be performed by applying a pressure of 900 MPa to 1100 MPa to the slurry.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a partially cut-away perspective view showing a double-layer composite metal powder particle according to an exemplary embodiment of the present disclosure;

FIG. 2 is a flow chart showing a method of manufacturing a soft magnetic core according to an exemplary embodiment of the present disclosure; and

FIG. 3 is a flow chart showing a process of manufacturing the soft magnetic core by using the double-layer composite metal powder particle.

### DETAILED DESCRIPTION

Exemplary embodiments of the present disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

Double-Layer Composite Metal Powder Particle 10

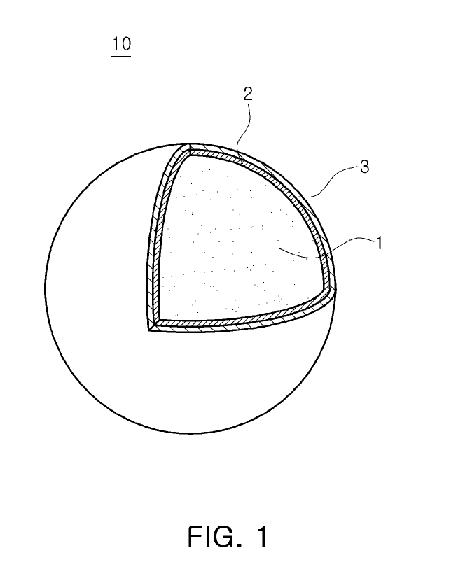

FIG. 1 is a partially cut-away perspective view showing a double-layer composite metal powder particle according to an exemplary embodiment of the present disclosure.

In the exemplary embodiment of the present disclosure, a double-layer composite metal powder particle 10 may include an Fe-based powder particle 1; an insulating layer 2; and a lubricating wax coating layer 3.

Hereinafter, the double-layer composite metal powder particle 10 and a method of manufacturing the same will now be described in detail with reference to FIG. 1.

(a) Preparing Fe-Based Powder Particle 1

The Fe-based powder particle 1 as a basic material of the double-layer composite metal powder particle 10 according to the exemplary embodiment of the present disclosure may be pure iron or an Fe-based alloy.

Technically speaking, pure iron indicates iron not containing impurities at all but having 100% purity. However, since it is difficult to completely remove impurities such as carbon, nitrogen, silicon, phosphorus, sulfur, and the like, included in pure iron, pure iron generally refers to iron having a level of purity higher than that of the other irons, and in the present disclosure, the term ‘pure iron’ is used to have a general meaning.

The Fe-based alloy is obtained by adding at least one alloying element, other than Fe, to the Fe, to thereby show properties of a metal. The alloying element is not specifically limited, as long as the alloying element increases electric resistance, and may be at least one selected from silicon (Si), aluminum (Al), chromium (Cr), molybdenum (Mo) and boron (B).

The silicon (Si), aluminum (Al), chromium (Cr), molybdenum (Mo) and boron (B) may have excellent effects in increasing resistance, as compared to other alloying elements.

Meanwhile, the at least one alloying element may be included in a content of 3.5 to 10 wt % based on the Fe-based alloy. As the content of the at least one alloying element is increased, electrical resistance may be increased to decrease a core loss value of a soft magnetic core 100, and in order to have the core loss value of 40 W/kg or less for being used in a motor, the content of the at least one alloying element should be 3.5 wt % or more. In addition, in the case in which the content of the at least one alloying element is greater than 10 wt %, the content of the at least one alloying element in the manufactured soft magnetic core 100 is increased, such that a magnetic flux density is 1.5 T or less, a critical numerical value for being used in the motor, and the density of the soft magnetic core 100 is 7.6 g/cm³ or less, relatively difficult to be applied to the motor.

Therefore, the at least one alloying element may be included in the content of 3.5 wt % to 10 wt %, in the alloy formed of Fe and an alloying element.

An average particle size of the Fe-based powder particle 1 may be 100 μm to 200 μm. In the case in which the average particle size of the Fe-based powder particle 1 is less than 100 μm, the magnetic flux density of the manufactured core at the time of manufacturing the core is decreased, and in the case in which the average particle size of the Fe-based powder particle 1 is more than 200 μm, magnetic flux density is increased but core loss is increased, and in particular, eddy current loss, a problem at high frequencies, is rapidly increased. Therefore, the Fe-based powder particle 1 having the average particle size of 100 μm to 200 μm may be prepared.

(b) Forming of Insulating Layer 2

The Fe-based powder particle 1 may have an insulating layer 2 formed on a surface thereof. The insulating layer is provided to decrease eddy current loss by electrically separating Fe-based powder particles 1 from each other. The insulating layer 2 may include an alkali-halogen compound.

The alkali-halogen compound in the present disclosure collectively refers to a compound formed of a group 1 alkali metal and a group 17 halogen element from the periodic table, through an ionic bond.

In the case of using a composite metal powder having an insulating coating layer using an insulating material such as phosphate in the related art to manufacture the core, electrical conductivity may be rapidly increased due to phase transformation of the insulating layer of the composite metal powder during a heat-treatment process at a high temperature for decreasing hysteresis loss in the manufactured core. In the case in which electrical conductivity is increased, since the eddy current loss is increased, there is a limitation in increasing the temperature in the heat-treatment.

However, in the case in which the alkali-halogen compound constitutes the insulating layer as described in the exemplary embodiment of the present disclosure, a melting point of 1000° C. or higher may be generally provided due to strong electrostatic attraction of the material itself, and a resistance to high temperatures may be relatively excellent.

Therefore, even when the heat-treatment is performed at a temperature of 600° C., a general heat-treatment temperature, the phase transformation or the increase in the electric conductivity of the insulating layer is not generated, such that the eddy current loss is not increased, and since the high temperature resistance is relatively high as compared to the insulating material such as phosphate used in the related art, decrease in the core loss may be expected.

The alkali-halogen compound according to the exemplary embodiment of the present disclosure may include lithium fluoride (LiF). A band gap energy of the lithium fluoride (LiF) is 12.6 eV, higher than that of other alkali-halogen compounds, such that electrical insulating properties of the lithium fluoride may be relatively excellent. Therefore, in order to obtain electrical insulating properties of the same level, the lithium fluoride may be thinly coated as compared to the other compounds. The relatively thin coating may increase the fraction of the Fe-based particle in a unit volume of the manufactured core to improve the magnetic flux density.

In addition, the insulating layer may have a thickness of 30 nm to 300 nm. In the case in which the thickness of the insulating layer is more than 300 nm, the magnetic flux density of the core is decreased, and in the case in which the thickness of the insulating layer is less than 30 nm, the insulating effect is not sufficient, such that core loss is increased. In addition, cracks may be generated in the insulating layer at the time of pressing molding, such that a tunneling effect may be generated, and therefore, the insulating effect may be further decreased.

(C) Forming of Lubricating Wax Coating Layer 3

The lubricating wax coating layer 3 may be formed on the insulating layer 2 formed on the surface of the Fe-based powder particle 1 to manufacture a double-layer composite metal powder particle 10. The lubricating wax coating layer 3 may be formed on each powder particle 1, such that frictional force between the double-layer composite metal powder particles 10 or frictional force between the double-layer composite metal powder particle 10 and a molded wall may be significantly decreased. For example, in the case of using the double-layer composite powder particle 10 of the exemplary embodiment of the present disclosure to mold the core, the powder particles may contact to each other and be crushed due to external pressure, such that at the time of performing a warm-molding to manufacture the core, a lubricating wax in a solid-phase may be changed to have a liquid-phase, frictional force may be decreased, residual stress caused by the pressing molding may be decreased and hysteresis loss may be decreased, whereby a core having relatively low core loss may be ultimately manufactured. In the related art, an Fe-based powder is mixed with a lubricating powder of several μm to be molded. However, when mixing is not uniformly performed, portions containing a small amount of the lubricating powder have increased frictional force, such that the hysteresis loss may be increased, and, in the case in which the content of the lubricating powder is relatively, extremely high, the residual carbon content after being molded is increased, having a negative effect in view of magnetic properties. Therefore, in the case in which the lubricating wax is coated on the surface of the Fe-based powder as suggested in the present disclosure, defects caused by non-uniform mixing of a lubricating powder may be removed.

The lubricating wax coating layer 3 may be formed by melting the lubricating wax so as to be in a liquid-phase and then dipping the Fe-based powder particle 1 having the insulating layer 2 formed thereon, or applying the lubricating wax in the liquid phase onto the insulating layer 2 formed on the surface of the Fe-based powder particle 1 by a spraying scheme and then performing a drying process, but the present disclosure is not limited thereto.

The lubricating wax forming the lubricating wax coating layer 3 may have a melting point of 100° C. to 150° C. The reason is that in the case of using the double-layer composite metal powder particle 10 of the present disclosure to mold the core, the case in which a molding temperature is generally 80° C. or higher is commonly generated, and in the case in which the melting point of the lubricating wax is a high temperature more than 150° C., the lubricating wax is not changed into the liquid phase at the molding temperature, such that an effect that the frictional force between the powder particles or between the powder and the mold is decreased may be significantly decreased.

The lubricating wax may include at least one of ethylene bis stearamide (EBS), zinc-stearate and polyethylene.

The melting point of the ethylene bis stearamide (EBS) may be about 141° C. to 146° C., the melting point of the zinc-stearate may be about 121° C. to 124° C., and the melting point of the polyethylene may be about 100° C. to 110° C.

The lubricating wax coating layer 3 may have a thickness of 300 nm to 700 nm. In the case in which the thickness of the lubricating wax coating layer 3 is less than 300 nm, since the lubricating wax being molten enough to decrease frictional force between the powder particles or between the powder particles and the mold may not sufficiently cover the powder at the time of pressing molding, the insulating coating layer may be damaged, and in the case in which the insulating coating layer is damaged, core loss may be increased. In addition, in the case in which the thickness of the lubricating wax coating layer 3 is more than 700 nm, a rate of magnetic substance included in the core formed of the double-layer composite metal powder 3 of the present disclosure may be decreased, such that the molding density and the magnetic flux density may be decreased and the core loss may be increased again. Therefore, the lubricating wax coating layer 3 may have a thickness of 300 nm to 700 nm.

Method of Manufacturing Soft Magnetic Core 100

According to another exemplary embodiment of the present disclosure, a method of manufacturing a soft magnetic core may include: preparing an Fe-based powder particle 1 S1; forming an insulating layer 2 including an alkali-halogen compound on a surface of the Fe-based powder S2; forming a lubricating wax coating layer 3 on the insulating layer to prepare a double-layer composite metal powder particle 10 S3; preparing a slurry 20 including the double-layer composite metal powder particle 10 S4; and pressing molding the slurry to manufacture a core 100 S5.

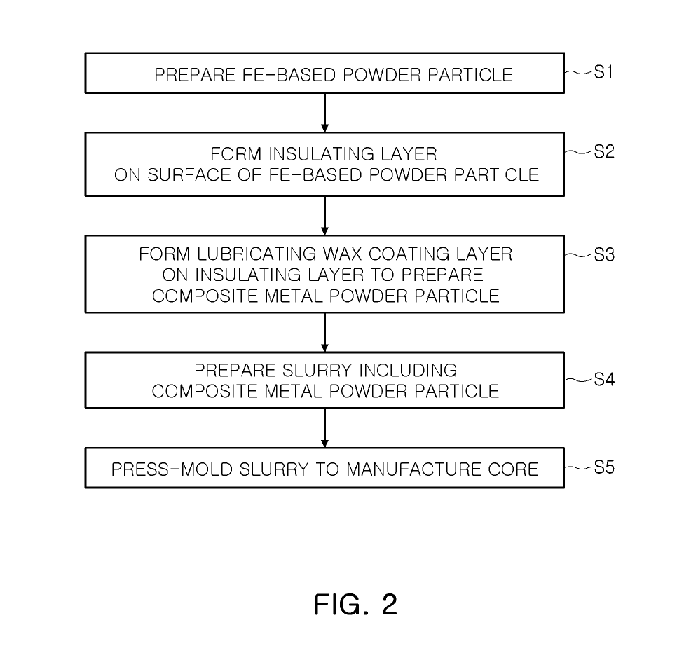

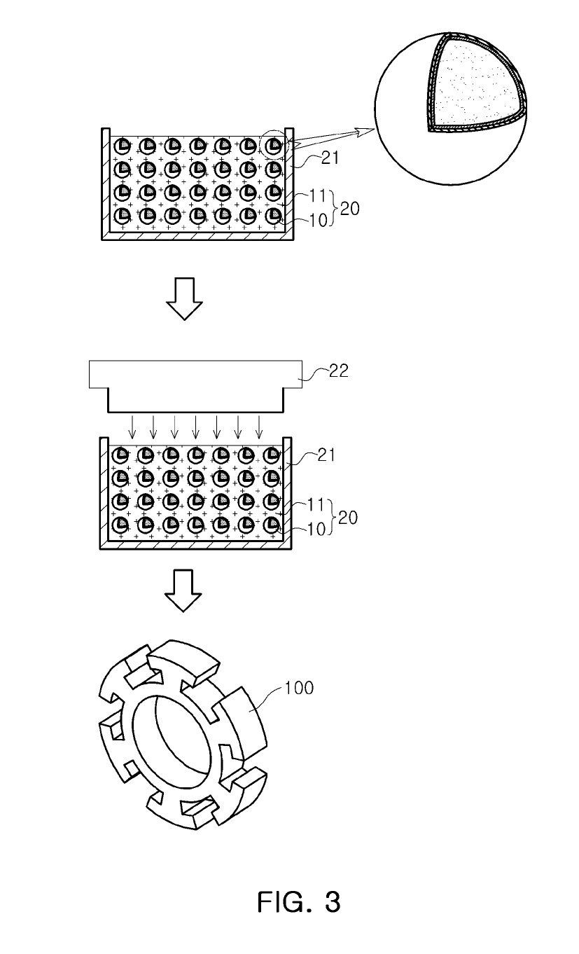

FIG. 2 is a flow chart showing the method of manufacturing the soft magnetic core 100 according to the exemplary embodiment of the present disclosure, and FIG. 3 is a flow chart showing a process of manufacturing the soft magnetic core 100 by using the double-layer composite metal powder particle 10.

Since the preparing of the Fe-based powder; the forming of the insulating layer; and the forming of the lubricating wax coating layer to prepare the double-layer composite metal powder particle 10 are described above, the overlapped portions of explanations will be omitted, and the method of manufacturing the soft magnetic core will be described with reference to FIGS. 2 and 3 based on the differences.

(d) Preparing of Slurry 20

The slurry 20 including the double-layer composite metal powder particle 10 prepared by the exemplary embodiment of the present disclosure as described above may be prepared. The slurry 20 may include the double-layer composite metal powder particle 10 and an additive 11, wherein the additive is not limited but may include a binder or a solvent.

The binder may be at least one selected from a group consisting of water glass, polyimide, polyamide, silicon, phenolic resins and acryl, but the present disclosure is not limited thereto.

In addition, a volatile solvent may be added to control the viscosity of the slurry 20, wherein the volatile solvent may be at least one of toluene, alcohol, and methyl ethyl ketone (MEK), but the present disclosure is not limited thereto.

(e) Manufacturing of Core

The prepared slurry 20 is used to manufacture the soft magnetic core 100 having a required shape, wherein a method of inserting the slurry 20 into the mold 21 having the core shape and then pressing molding using a press machine 22 may be used, but the present disclosure is not limited thereto.

The pressing molding may be performed by applying a pressure of 900 MPa to 1100 MPa, a high pressure as compared to the pressure used in molding the general powder of the related art, in a temperature range of between 150° C. to 250° C., for example, the lubricating wax coating layer 3 of the present disclosure is changed into the liquid-phase.

At the time of pressing molding, in the case in which the temperature is less than 150° C., the lubricating wax coating layer 3 is not sufficiently changed into the liquid-phase, such that the effect that the frictional force is decreased may not be sufficiently provided, and in the case in which the temperature is more than 250° C., the viscosity of the lubricating wax coating layer in the liquid-phase is significantly decreased, and a portion thereof is changed into residual carbon, such that the frictional force between the powder particles may be increased, and a possibility that the insulating layer 2 will be destroyed is increased.

In regard to the pressure in the molding, even when the pressure is 900 MPa or more, the density of the manufactured core may not be greatly increased, and in the case in which the pressure is less than 900 MPa, the density of the finally manufactured soft magnetic core may not be sufficiently secured. In addition, in the case in which the pressure in the molding is more than 1100 MPa, a life-span of the mold may be rapidly decreased.

Therefore, the molding of the soft magnetic core 100 may be performed by applying the pressure of 900 MPa to 1100 MPa thereto at a temperature of 150° C. to 250° C.

(f) Performing of Heat-Treatment

An additional heat-treatment may be performed in order to further decrease hysteresis loss and core loss of the manufactured soft magnetic core.

In the case of the soft magnetic core manufactured by using the composite metal powder of the present disclosure, since the insulating layer has a melting point of 1000° C. or higher, the heat-treatment may be performed at a temperature of 600° C. or higher to manufacture the soft magnetic core having decreased hysteresis loss and decreased core loss.

### Experimental Example 1

The following Table 1 shows density, magnetic flux density, core loss of a soft magnetic core manufactured depending on a thickness of a insulating layer of a double-layer composite metal powder particle 10.

The double-layer composite metal powder particle 10 used in manufacturing the soft magnetic core of Experimental Example 1 may include an Fe-based powder particle 1 satisfying the following Equation: D50=170 μm, an insulating layer 2 having a thickness shown in the following Table 1 and formed of lithium fluoride, and a lubricating wax coating layer 3 having a thickness of 400 nm.

TABLE 1

| Thickness (nm) of | Density | Magnetic flux density | Core Loss |
|---|---|---|---|
| Insulating Layer | (g/cm³) | (T) at 10 KA/m | (W/kg) |
| 20* | 7.67 | 1.72 | 51 |
| 25* | 7.67 | 1.71 | 50 |
| 30 | 7.66 | 1.71 | 45 |
| 40 | 7.66 | 1.70 | 44 |
| 100 | 7.65 | 1.69 | 42 |
| 200 | 7.64 | 1.69 | 42 |
| 250 | 7.63 | 1.67 | 41 |
| 280 | 7.62 | 1.66 | 41 |
| 300 | 7.61 | 1.65 | 40 |
| 350* | 7.60 | 1.64 | 40 |
| 400* | 7.59 | 1.63 | 40 |
| 500* | 7.58 | 1.60 | 40 |

*Indicates Comparative Example.

It can be appreciated from Table 1 above that as the thickness of the insulating layer is increased, a molding density thereof is decreased, and thus, the magnetic flux density B is also decreased. In contrast, it can be appreciated in the core loss that in the case in which the thickness of the insulating layer becomes increased, an insulating effect becomes increased, but in the case in which the thickness thereof is greater than 300 nm, the insulating effect is saturated and the core loss is not decreased anymore. In addition, it can be appreciated that based on the thickness of the insulating layer of 30 nm, core loss is significantly decreased. For example, it can be appreciated that the thickness of a critical insulating layer is 30 nm to 300 nm due to motor properties, for example, magnetic flux density should be relatively high and core loss should be decreased. In detail, the thickness of the critical insulating layer may be 100 nm to 200 nm.

### Experimental Example 2

The following Table 2 shows density, magnetic flux density, and core loss of a soft magnetic core manufactured depending on the thickness of the lubricating wax coating layer of the double-layer composite metal powder particle 10.

The double-layer composite metal powder particle 10 used in manufacturing the soft magnetic core of the Experimental Example 2 may include an Fe-based powder particle 1 satisfying the following Equation: D50=170 μm, an insulating layer 2 having a thickness of 100 nm and formed of lithium fluoride, and a lubricating wax coating layer 3 having a thickness shown in the following Table 2.

TABLE 2

| Thickness (nm) of | | Magnetic | |
|---|---|---|---|
| Lubricating Wax | Density | flux density | Core Loss |
| Coating Layer | (g/cm³) | (T) at 10 KA/m | (W/kg) |
| 100* | 7.67 | 1.72 | 50 |
| 200* | 7.66 | 1.71 | 49 |
| 250* | 7.66 | 1.71 | 49 |
| 300 | 7.65 | 1.70 | 42 |
| 350 | 7.65 | 1.70 | 40 |
| 400 | 7.65 | 1.69 | 41 |
| 600 | 7.64 | 1.67 | 41 |
| 650 | 7.64 | 1.66 | 41 |
| 700 | 7.63 | 1.65 | 41 |
| 750* | 7.63 | 1.64 | 42 |
| 800* | 7.62 | 1.63 | 43 |
| 900* | 7.60 | 1.60 | 43 |

*Indicates Comparative Example.

In order to apply the manufactured core to the motor, the magnetic flux density at a magnetic field of 10 KA/m should be 1.5 T or more, and to do this, the core after being molded should have a density of 7.6 g/cm³ or more.

The properties of the core for a motor were satisfied at each thickness used in the Experimental Examples.

Meanwhile, as shown in Table 2, in the case in which the thickness of the lubricating wax coating layer is less than 300 nm, an insulating coating layer is not protected but rather, is partially damaged, such that the core loss value is increased, and in the case in which the thickness of the lubricating wax coating layer is more than 700 nm, the density of the manufactured soft magnetic core is relatively low, such that the core loss value is increased again.

Therefore, it could be confirmed from the experiments that the thickness of the lubricating wax coating layer for obtaining the soft magnetic core having relatively high density and magnetic flux density and relatively low core loss is 300 to 700 nm.

The double-layer composite metal powder particle 10 according to the exemplary embodiment of the present disclosure may additionally include the lubricating wax coating layer 3 formed on the surface of the insulating layer 2, such that at the time of molding the core, a lubricant may be uniformly dispersed, whereby a core having relatively high density and low core loss may be obtained. In addition, the insulating layer 2 includes an alkali-halogen compound, such that the core loss may be decreased and a heat-treatment at a relatively high temperature may be performed.

According to the method of manufacturing the soft magnetic core according to the exemplary embodiment of the present disclosure, the soft magnetic core having a density of 7.6 g/cm³ or more and low core loss may be obtained.

As set forth above, according to exemplary embodiments of the present disclosure, the double-layer composite metal powder particle capable of being used in manufacturing a core having a relatively low core loss, high density and improved magnetic flux density, and the method of manufacturing the soft magnetic core may be provided.

While exemplary embodiments have been shown and described above, it will be apparent to those skilled in the art that modifications and variations could be made without departing from the spirit and scope of the present disclosure as defined by the appended claims.

What is claimed is:

1. A double-layer composite metal powder particle comprising:
an Fe-based powder;
an insulating layer formed on a surface of the Fe-based powder and including an alkali-halogen compound; and
a lubricating wax coating layer formed on the insulating layer.

2. The double-layer composite metal powder particle of claim 1, wherein the alkali-halogen compound includes lithium fluoride (LiF).

3. The double-layer composite metal powder particle of claim 1, wherein the insulating layer has a thickness of 30 nm to 300 nm.

4. The double-layer composite metal powder particle of claim 1, wherein the lubricating wax coating layer has a thickness of 300 nm to 700 nm.

5. The double-layer composite metal powder particle of claim 1, wherein a melting point of lubricating wax used in the lubricating wax coating layer is 100° C. to 150° C.

6. The double-layer composite metal powder particle of claim 1, wherein the lubricating wax includes at least one of ethylene bis stearamide (EBS), zinc-stearate and polyethylene.

7. The double-layer composite metal powder particle of claim 1, wherein an average particle size of the Fe-based powder is 100 μm to 200 μm.

8. The double-layer composite metal powder particle of claim 1, wherein the Fe-based powder includes at least one alloying element of silicon (Si), aluminum (Al), chromium (Cr), molybdenum (Mo) and boron (B).

9. The double-layer composite metal powder particle of claim 8, wherein the alloying element is included in a content of 3.5 to 10 wt % based on the Fe-based powder.

10. A method of manufacturing a soft magnetic core, the method comprising:
preparing an Fe-based powder;
forming an insulating layer including an alkali-halogen compound on a surface of the Fe-based powder;
forming a lubricating wax coating layer on the insulating layer to prepare a double-layer composite metal powder particle;
preparing a slurry including the double-layer composite metal powder particle; and
pressing molding the slurry to manufacture a core.

11. The method of claim 10, wherein the pressing molding is performed at a temperature of 150° C. to 250° C.

12. The method of claim 10, wherein the pressing molding is performed by applying a pressure of 900 MPa to 1100 MPa to the slurry.
